(19) United States
(12) Patent Application Publication
(10) Pub. No.: US 2007/0023448 A1
(43) Pub. Date: Feb. 1, 2007

(54) BOTTLE ADAPTER

(75) Inventor: David Kleinschrodt, Pleasantville, NJ (US)

Correspondence Address: IAN F. BURNS & ASSOCIATES, P.O. BOX 71115, RENO, NV, 89570, US

(73) Assignee: Globe Vending Company, Pleasantville, NJ (US)

(21) Appl. No.: 11/424,074

(22) Filed: Jun. 14, 2006

Related U.S. Application Data
(60) Provisional application No. 60/691,466, filed on Jun. 16, 2005.

(51) Int. Cl. B65G 59/00

(52) U.S. Cl. 221/312 R

(57) ABSTRACT

A bottle adapter device having a clasping portion configured to fit over the neck or cap section of a bottle container and a canopy portion configured to give the beverage bottle an overall profile of a beverage can, is disclosed. Beverage bottles that include the bottle adapter device may be used conveniently in vending machines designed primarily for canned beverages.

### CROSS REFERENCE TO RELATED AND CO-PENDING APPLICATIONS

The present invention claims priority to provisional application Ser. No. 60/691,466, filed on Jun. 16, 2005 and titled, Bottle Adapter. The contents of which are herein incorporated by reference.

### BACKGROUND OF THE INVENTION

The present invention relates to an adapter device to convert bottle containers into a form suitable for use in vending machines that dispense beverage containers. In particular, the modified bottle containers of the present invention are suitable for use in vending machines previously designed primarily to store and dispense beverages available in cans.

Beverage dispensing machines, such as vending machines that provide canned beverages, are known in the art. Other types of vending machines provide beverages in the form of plastic bottles; however, these vending machines typically require a storage and delivery mechanism for transfer of the beverage bottles from storage to the point of delivery of the bottled beverage to the vending machine customer different from the vending machines that use canned beverages. For example, the non-uniform shape of bottled beverages may require specific storage arrangements to allow specialized transfer (e.g., elevator type mechanism) of the bottled beverage in a stepwise fashion in order to deliver the bottle to the vending machine customer.

On the other hand, vending machines for canned beverages typically require a simpler container storage and transfer arrangement since the more uniform nature (circular cylinder) of a beverage can (compared to a bottle) would allow for stacked storage of the can containers for gravity delivery into a transfer chute for conveyance to the vending machine customer. The transfer chute is typically designed to allow for fast and simple movement of the uniform shaped beverage cans from the can storage area to the vending machine customer access point. However, the latter design is not conducive to efficient transport of bottle-shaped containers. If bottle-shaped containers were to be used in vending machines designed for can containers, the irregular shape of the bottles may allow for tipping, leaning or slanting movements of the bottle container during transit down the transfer chute, especially around comers, leading to jamming or blockage of the transfer chute.

It is desirable for vending machines designed for canned beverages to be able to accommodate beverages available in bottled form without incurring the potential jamming or blockage problems inherent with the use of bottle-shaped containers in some vending machines. The adapter device and resultant modified bottles oft he present invention overcome the deficiencies of vending machines designed primarily for canned beverages and allow the use of bottle-shaped containers in a wide variety of beverage vending machines.

### BRIEF SUMMARY OF THE INVENTION

Advantages of One or More Embodiments of the Present Invention

The various embodiments of the present invention may, but do not necessarily, achieve one or more of the following advantages:
provide a modified bottle that can be used in a can vending machine;
provide a bottle adapter that can be mounted to a cap of a bottle;
provide a bottle adapter that can be snap fit onto a bottle cap;
allow for bottles with bottle adapters to be used in a vending machine designed for cans; and
provide a bottle adapter that when mounted to a bottle simulates the profile of a can.

These and other advantages may be realized by reference to the remaining portions of the specification, claims, and abstract.

Brief Description

In one embodiment of the present invention, a bottle adapter device is provided that includes (a) a clasping portion configured to fit over the neck or cap section of a bottle container and (b) a canopy portion coupled to the clasping portion and configured to form a top for the bottle container, wherein the canopy portion comprises a diameter substantially the same as the bottle container and an upper surface substantially similar in profile to a bottom surface of the bottle container.

In another embodiment of the present invention, a beverage bottle is provided that comprises (a) a bottle container suitable for holding liquids and (b) an adapter device removably coupled to the cap or neck section of the bottle container, wherein the adapter device is configured to provide the modified beverage bottle with an overall profile of a beverage can.

Another embodiment oft he present invention includes a bottle adapter device wherein the clasping portion is in the form a slip fit sleeve that fits snugly over the cap or neck section of the bottle container; the slip fit sleeve also may have locking tabs that fit over the lip of the neck or cap of the bottle container. Alternatively, the clasping portion of the bottle adapter device may be in the form of a wrap-around sleeve having an adhesive portion for securing the bottle adapter device to the bottle container.

The bottle adapter devices of the present invention allow the modified bottles to navigate through the inner workings of vending machine configured to handle beverage cans without the jamming and blocking problems previously encountered when unmodified bottle beverages are used in vending machines designed for canned beverages.

The above description sets forth certain features of representative embodiments disclosed herein. There are other features that will become apparent to those skilled in the art from this specification. In this respect, before explaining specific embodiments of the invention in detail, it is to be understood that the invention is not limited in its application to the details of the construction and to the arrangement of the components set forth in the following description or as illustrated in the drawings, nor is the invention necessarily a solution of each problem noted in the Background Section above. In addition, the various disclosed embodiments are capable of being practiced and carried out in various ways. Also, it is to be understood that the phraseology and terminology employed herein are for the purpose of brief description and should not be regarded as limiting.

### BRIEF DESCRIPTION OF THE DRAWINGS

Typical embodiments involving the current invention are shown in the accompanying drawings wherein:

FIG. 1A is substantially a front view of a vending machine that may use bottle adapter devices of the present invention

FIG. 1B is substantially a side cross-sectional view of a vending machine that may use bottle adapter devices of the present invention.

FIG. 2 is a break-away top and side perspective view of a can cooler assembly section of a vending machine that may use bottle adapter devices of the present invention.

FIG. 3 is substantially a top perspective view of a bottle adapter device of the present invention.

FIG. 4 is substantially a bottom perspective view of a bottle adapter device of the present invention.

FIG. 5 is substantially a side view of a bottle adapter device of the present invention.

FIG. 6 is substantially a side cross-sectional view of a bottle adapter device of the present invention.

FIG. 7 is substantially a side cross-sectional view of a bottle and the bottle adapter device oft he present invention prior to assembly.

FIG. 8 is substantially a side cross-sectional view of the bottle and the bottle adapter device of FIG. 7 after assembly showing a modified bottle.

In the Detailed Description below, the applicants may utilize various spatially orienting terms such as “upper,” “lower,” “horizontal,” and “vertical.” It is understood that these terms are used for ease of description of various embodiments with respect to the drawings but are not necessarily in themselves limiting or requiring an orientation as thereby described in the Detailed Description.

### DETAILED DESCRIPTION OF THE INVENTION

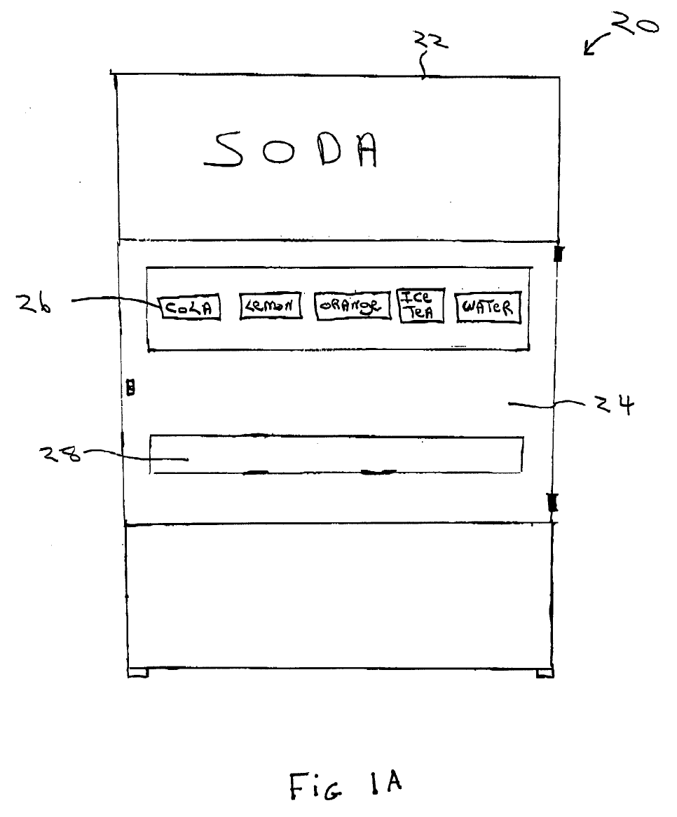

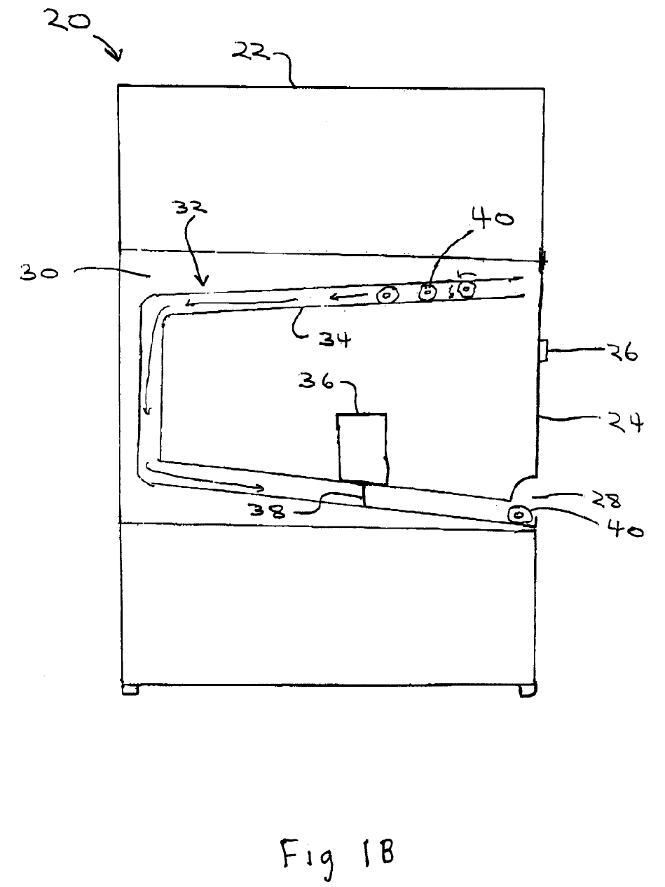

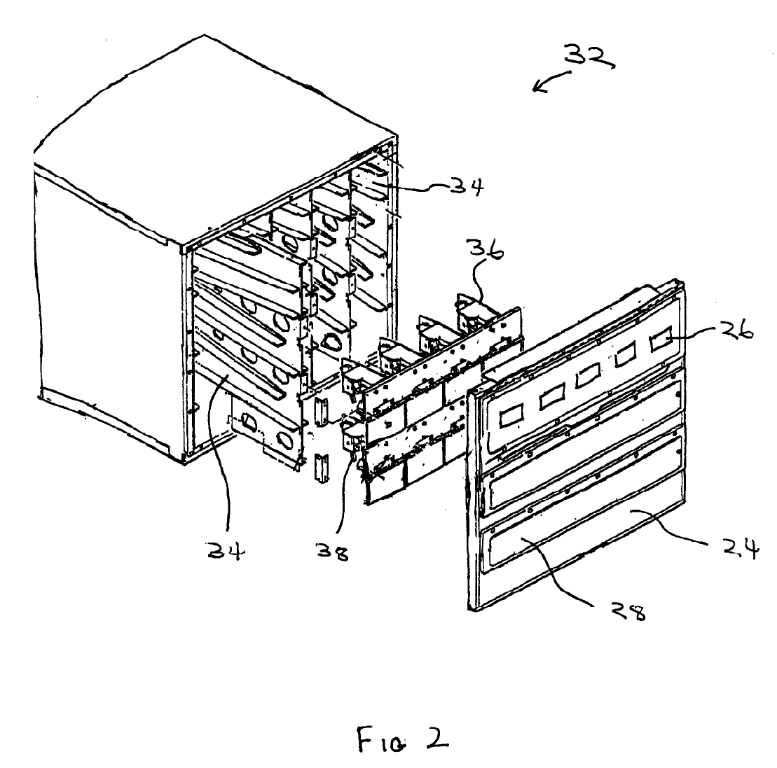

Referring to FIGS. 1A, 1B and 2, modified bottles 40 of the present invention may be used in vending machines configured to handle canned beverages. Vending machines 20 of this type can include a housing 22 that has a front door 24 and an internal cavity 30. Selection buttons 26 and a discharge opening 28 can be located in front door 24. A cooler apparatus 32 may be mounted in cavity 30. Cooler apparatus 32 may include a transfer chute 34, a gate actuator 36 and a gate 38. The modified bottles 40 can roll down chute 34 and be dispensed by gate actuator 36 and 38 to discharge opening 28. Modified bottles 40 of the present invention are suitable for use in vending machine 20.

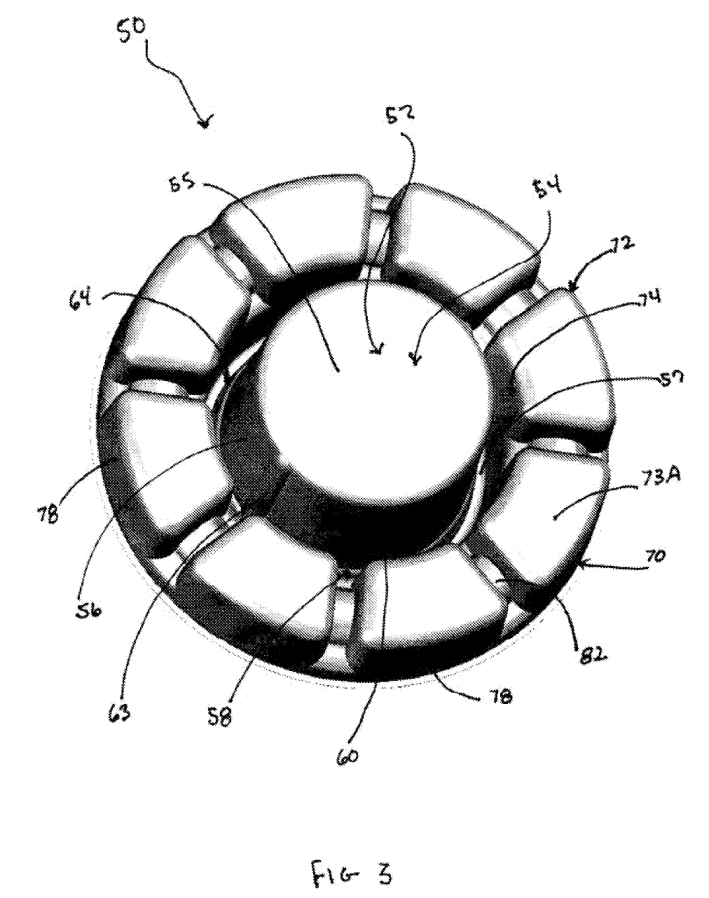

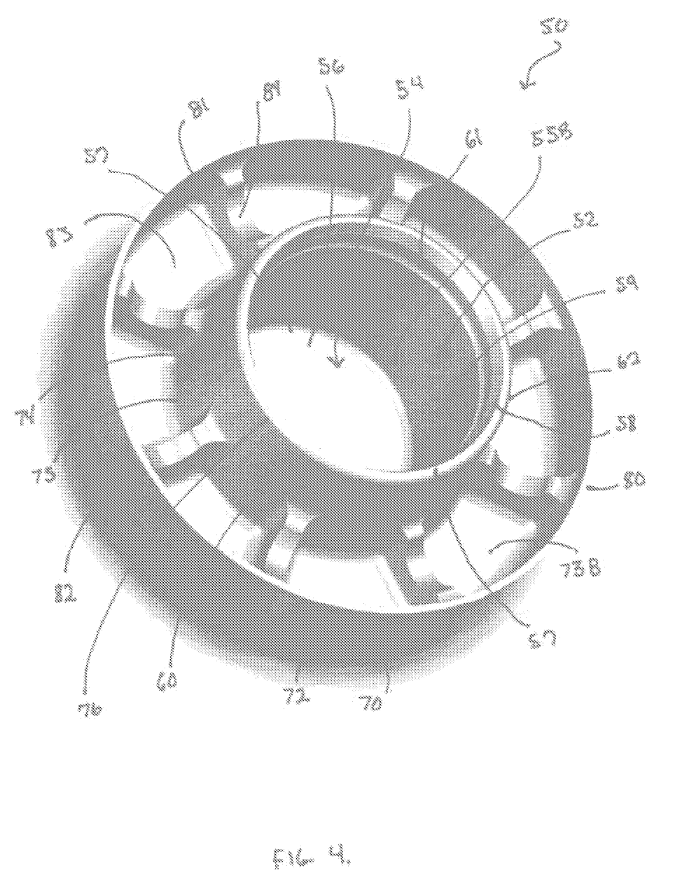

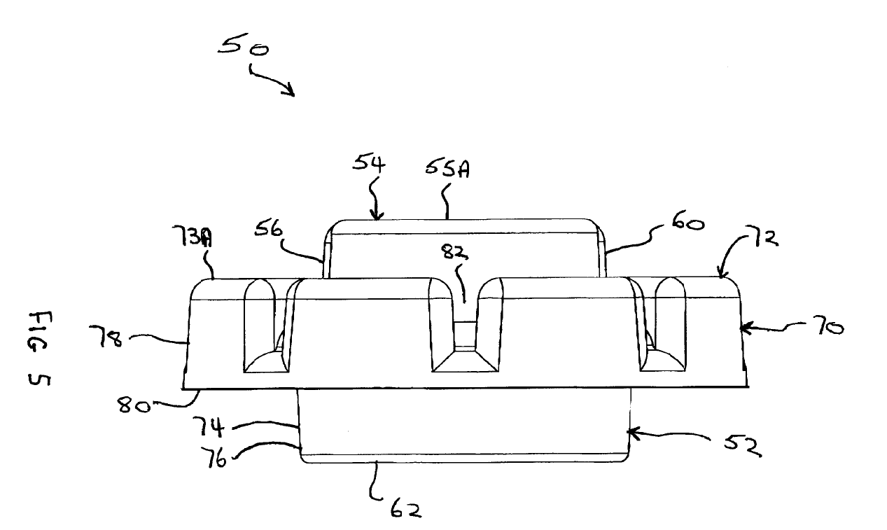

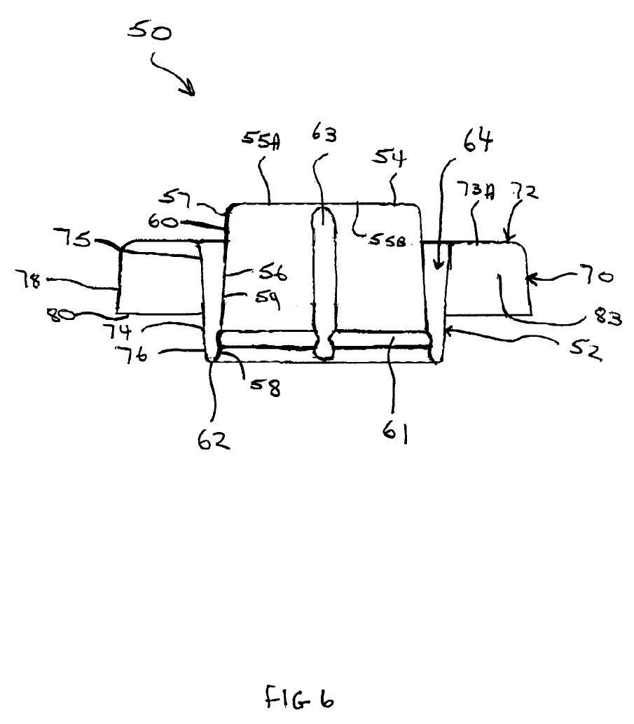

Referring now to FIGS. 3-6, a bottle adapter device 50 is shown. Bottle adapter device 50 is generally circular in shape. Bottle adapter device 50 may comprise a clasping or clamping portion 52 and a canopy portion 70. Clasping or clamping portion 52 is adapted to grasp a bottle top or cap. Clasping or clamping portion can include a cover portion 54 that has a top surface 55A and a bottom surface 55B. An annular sleeve or wall 56 extends downwardly from cover portion 54. Sleeve 56 has ends 57 and 58. End 57 is connected to cover portion 54. Sleeve 56 further has an inner surface 59 and an outer surface 60.

An annular groove 61 can be located on inner surface 59 toward end 58 and extends completely around wall 56. A lip 62 is located below groove 61. An air channel 63 is located on inner surface 59 and extends between ends 57 and 58. Air channel 63 is used to allow air to escape when the bottle adapter is being mounted to a bottle. An open moat or well area 64 is located between sleeve 56 and a wall 74.

Canopy portion 70 may include a ring portion 72 that has a top surface 73A and a bottom surface 73B. Another annular wall 74 has ends 75 and 76. Ends 76 and 58 are connected together at lip 62 such that wall 74 is connected to sleeve 56. Annular wall 74 extends downwardly from ring portion 72. Outer wall 78 extends downwardly from surface 73A and forms a support. A rim 80 is located at the base of wall 78. Several web sections 81 are located in canopy 70 and extend between wall 78 and wall 74. Web sections 81 strengthen and add rigidity to the bottle adapter. Web sections 81 have a slot 84. Troughs 83 are defined between the web sections 81. A recess 82 is defined by the back side of web sections 81 in canopy 70.

The bottle adapter device 50 of the present invention typically can be constructed of plastic material, such as PVC (polyvinylchloride), for example. Plastic material thickness of the bottle adapter device can vary depending upon the strength required for surviving the rigors of the vending machine machinery. Alternatively, the bottle adapter devices may be constructed of any materials having suitable strength characteristics to withstand the transit process through the vending machine; for example, the bottle adapter device may be constructed of paperboard, preferably of a moisture-resistant grade. The bottle adapter devices of the present invention may be manufactured by thermoforming, injection or vacuum molding, and related processes.

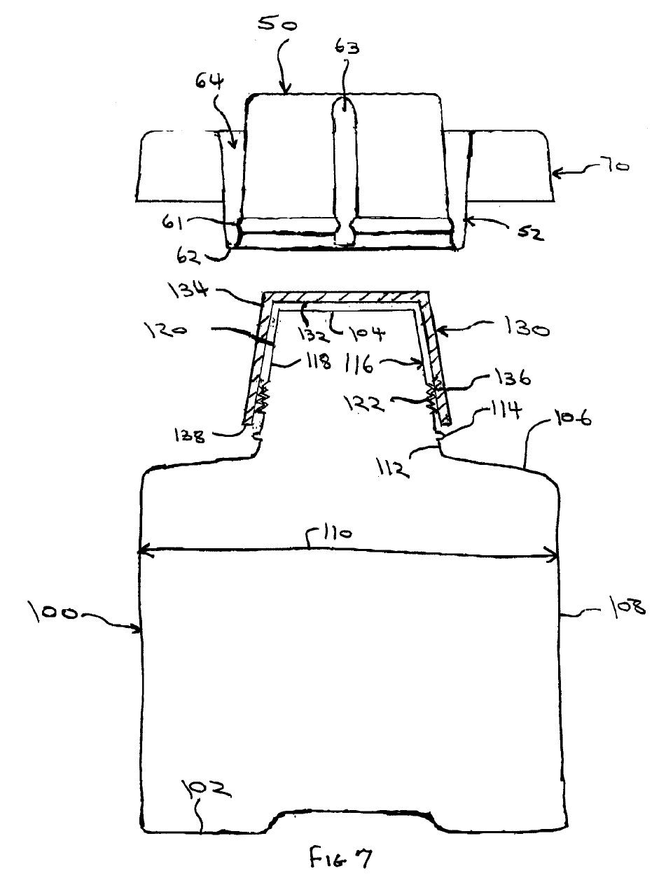

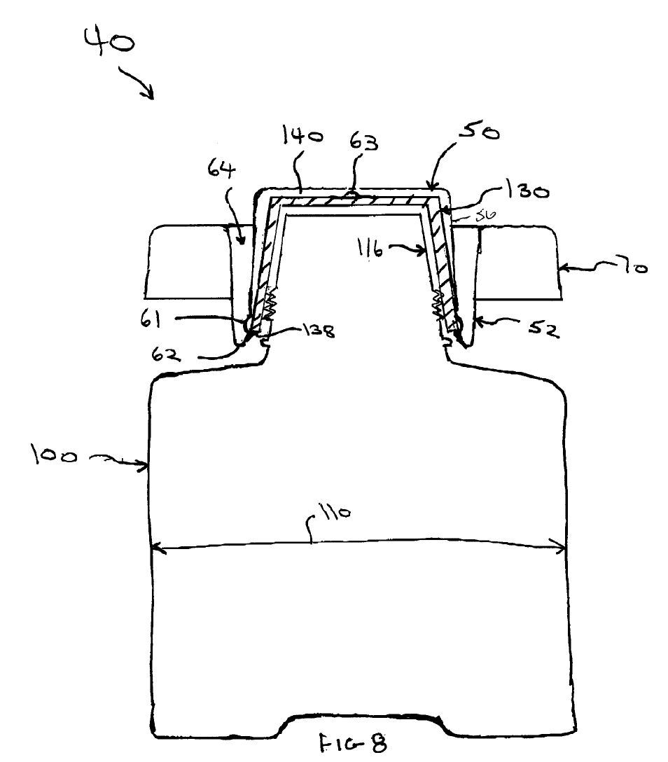

Turning now to FIGS. 7 and 8, a modified bottle 40 is shown. Modified bottle 40 can comprise a container or bottle 100 with an attached bottle adapter 50. Container or bottle 100 can be many different types and sizes of bottles. Bottle 100 can have a bottom 102, top 104, shoulder 106 and cylindrical wall 108. Bottle 100 can have dimensions that include a diameter 110. Bottle 100 can further include a neck portion 112 and a spout 116. Spout 116 can be used by a user to drink a liquid beverage from. A rib 114 extends from neck 112. Spout 116 can have an inner surface 118 and an outer surface 120. Threads 122 may be located on outer surface 120 for the attachment of a cap.

The beverage bottle containers 100 of the present invention include those containers having a range of sizes, for example, from about 8 ounces up to about one liter. Typically, the containers will be from 10 to 12 ounces in volume. The bottle container portion of the present invention may be made of plastic or glass, although typically, the bottle container portion is plastic, such as modified polyester or other plastic material suitable for use with beverages, such as drinking water or carbonated beverages (Coca Cola™, Pepsi™, 7-Up™, ice tea and related diet- form beverages, for example). Beverages supplied in the form of bottles (instead of cans) may be more desirable from a consumer standpoint, particularly in the case of bottled water.

With continued reference to FIGS. 7 and 8, a bottle cap 130 can be mounted to bottle 100. Bottle cap 130 can have an inner surface 132 and an outer surface 134. Threads 136 are located on outer surface 134. Threads 136 of cap 130 mate with threads 122 of bottle 100 to form a sealed bottle as is known in the art. Cap 130 has an outer edge 138 that is located at the bottom of cap 130. Cap 130 can be formed from any suitable plastic. An airgap 140 is defined between cap 130 and bottle adapter 50 after bottle adapter 50 has been pressed onto cap 130.

FIG. 7 shows the bottle adapter 50 prior to being mounted on a bottle 100. During use, bottle adapter 50 would be pressed onto over cap 130 or slid onto cap 130. The diameter of clasping portion 52 at lip 62 is slightly smaller than the diameter of the cap at edge 138. As clasping portion 52 slides over cap 130, sleeve 56, groove 61 and lip 62 are forced outwardly away from the cap. Sleeve 56 is slightly flexible and can bend slightly.

Turning to FIG. 8, continued pressing of the bottle adpater forces clasping portion 52 to continue sliding toward shoulder 106 until groove 61 snaps onto edge 138. At this point, sleeve 56 moves inwardly toward cap 130 such that groove 61 grasps the edge 138 of cap 130. In this manner, bottle adapter 50 is retained or held to cap 130.

The air channel 63 allows air that is trapped in airgap 140 between the bottle cap 130 and cover 54 to escape when the bottle adapter is being mounted to the cap. If air channel 63 is not used, the air pressure contained in airgap 140 may prevent bottle adapter 50 from being completely pressed onto cap 130.

It is noted that bottle adapter 50 is removable from cap 130. After the modified bottle 40 has been dispensed from a can vending machine, a user grasping canopy 70 would pull upwardly on canopy 70 causing sleeve 56 to be forced away from cap 130. This would cause groove 61 to pop out of contact with edge 138 allowing removal of the bottle adapter device from bottle 100. The user would then have access to cap 130 the same as in a conventional bottle.

From FIG. 8, it can be seen that bottle adapter 50 has a diameter that is approximately the same diameter as that of bottle 100. Bottle adapter 50 forms a top of the bottle that simulates the profile of an end of a can. Bottle adapter 50 when coupled to the cap or neck section oft he bottle container provides a modified bottle 40 that has an overall profile of a beverage can.

The bottle adapter device of the present invention when mounted to a conventional bottle to create a different overall shape allows the bottles to navigate through the inner workings of vending machines configured to handle beverage cans without jamming or blocking problems that have been previously encountered when unmodified bottle beverages are used in vending machines designed for canned beverages.

Although the aforementioned bottle adapter devices are shown as separate units from the beverage bottle (and bottle cap), an alternative design oft he bottle adapter device may include a portion of the bottle adapter device that also acts as the cap portion oft he bottle. That is, the bottle adapter device may include a clasping portion configured to fit over the neck section of a bottle container where the canopy portion of the bottle adapter device further includes a threaded portion configured to act as the cap of the bottle by engaging corresponding threads on the top end of the bottle. In this case, when the beverage bottle is delivered to the customer, the bottle adapter device and bottle cap are removed as one piece.

We claims:

1. A bottle adapter device comprising:
(a) a clasping portion configured to fit over a neck or cap section of a bottle container; and
(b) a canopy portion coupled to the clasping portion and configured to form a top for the bottle container, wherein the canopy portion comprises a diameter substantially the same as the bottle container.

2. The device of claim 1 wherein the clasping portion further comprises:
(a) a cover having a top surface and a sleeve extending from the top surface;
(b) the sleeve having a first end attached with the top surface and a second end;
(c) the sleeve further having an inner surface and an outer surface; and
(d) a groove located on the inner surface toward the second end,

3. The device of claim 2 wherein the groove is adapted to grasp the cap section.

4. The device of claim 2 wherein a lip section is located adjacent the groove.

5. The device of claim 2 wherein at least one channel is located in the sleeve.

6. The device of claim 5 wherein the canopy portion further comprises an upper surface, the upper surface having a contour abut a bottom surface of a bottle container.

7. The device of claim 5 wherein a well is located between the clasping portion and the canopy portion.

8. The device of claim 1 wherein the canopy portion further comprises:
(a) a ring portion having a top surface and a wall extending from the top surface;
(b) the wall having a third end attached with the top surface and a fourth end; and
(c) an outer rim attached to the top surface.

9. The device of claim 8 wherein the fourth end is connected with the sleeve.

10. The device of claim 8 wherein at least one web is located in a portion of the top surface oft he outer rim.

11. A beverage bottle comprising:
(a) a bottle container suitable for holding liquids; and
(b) a bottle adapter device removably coupled to a neck or cap section of the bottle container, wherein in combination, the bottle adapter device and the bottle container are configured to have an overall profile of a beverage can.

12. The device of claim 11 wherein the bottle adapter further comprises:
(a) a clamping section adapted to grasp the neck or cap section; and
(b) a canopy portion connected to the clamping section and extending outwardly from the clamping section

13. The device of claim 12 wherein a groove is located in the clamping section and is adapted to grasp the neck or cap section.

14. The device of claim 12 wherein at least one channel is located in the clamping section.

15. The device of claim 12 wherein a well is located between the clamping portion and the canopy portion.

16. A bottle adapter device comprising:
(a) locking means for gripping a cap of a container, the locking means having a groove that is adapted to engage the cap; and
(b) support means coupled to the locking means and configured to form a top for the container, wherein the support means has a diameter that is substantially the same as the diameter of the container, the support means being adapted to simulate a bottom surface of the container.

17. The device of claim 16 further comprising:
(a) a sleeve extending from the locking section; and
(b) a wall extending from the support means, the sleeve and the wall being connected.

18. The device of claim 17 wherein at least one air channel is located in the sleeve.

19. A method of dispensing a container, but not all necessarily in the order shown, comprising:
(a) mounting a bottle adapter device to a container;
(b) inserting the container into a can dispensing machine; and
(c) dispensing the container from the can dispensing machine.

20. The method of claim 19 wherein the bottle adapter device prevents the container from twisting and jamming within the can dispensing machine.
